(19) United States
(12) Patent Application Publication
(10) Pub. No.: US 2004/0177014 A1
(43) Pub. Date: Sep. 9, 2004

(54) Systems and methods for ordering and distributing redemption instruments

(75) Inventor: James E. Cowell, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/383,174

(22) Filed: Mar. 5, 2003

(51) Int. Cl. G06F 17/60

(52) U.S. Cl. 705/35

(57) ABSTRACT

Systems and methods for ordering and distributing redeemable value instruments internationally are disclosed. The systems can include two microprocessor based systems located in different countries. One of the microprocessor based systems includes a computer readable medium with instructions executable for receiving a request to distribute a negotiable stored value card to the foreign country, and a message to a recipient in the foreign country. The systems also include a stock stored value card and a writer operable to load a value on the stock stored value card to create a negotiable stored value card. Various of the methods include receiving a request for a stored value card in one country that requests distribution in another country. The stored value card is prepared for distribution in the country in which it is distributed, and provided in exchange for a document control number communicated to a recipient in the country in which the stored value card is distributed.

### CROSS-REFERENCES TO RELATED APPLICATIONS

This application is related to U.S. patent application Ser. No. ______ (Attorney Docket No. 020375-034100US, entitled “Peripheral Point-Of-Sale Systems And Methods Of Using Such”, filed Feb. 19, 2003 by Eric M. Nelson et al.; and U.S. patent application Ser. No. 09/634,901, entitled “Point-of-Sale Payment System”, Filed Aug. 9, 2000 by Randy J. Templeton et al. Each of the aforementioned applications are assigned to an entity common herewith and incorporated herein by reference for all purposes. This application is further related to U.S. patent application Ser. No. 10/116,689, entitled “Systems and Methods for Performing Transactions at a Point-of-Sale”; U.S. patent application Ser. No. 10/116733, entitled “Systems and Methods for Deploying a Point-of-Sale System”; U.S. patent application Ser. No. 10/116686, entitled “Systems and Methods for Utilizing a Point-of-Sale System”, and U.S. patent application Ser. No. 10/116,735, entitled “Systems and Methods for Configuring a Point-of-Sale System”. Each of the aforementioned applications are assigned to an entity common herewith, were filed by Earney E. Stoutenburg et al. on Apr. 3, 2002, and are incorporated herein by reference for all purposes. Additionally, this application is related to U.S. patent application Ser. No. 10/163,188, entitled “Intra-Organization Negotiable Instrument Production And Messaging”, filed by Kenneth Algiene on Jun. 4, 2002, and assigned to an entity common hereto and incorporated herein by reference for all purposes. Yet further, this application is related to U.S. patent application Ser. No. ______ (attorney docket number 020375-001011US), entitled “Systems And Methods For Ordering And Distributing Incentive Messages”, and filed by James Everett Cowell et al. on Feb. 19, 2003, which is a continuation in part of U.S. patent application Ser. No. 10/187,475, entitled “Systems And Methods For Ordering And Distributing Incentive Messages”, and filed by Peter Michael Karas et al. on Jun. 28, 2002, which is a continuation in part of U.S. patent application Ser. No. 09/737,912, entitled “Online Method And System For Ordering And Having Delivered A Paper Greeting Message And Payment Instrument”, and filed on Dec. 15, 2000; and U.S. patent application Ser. No. 10/010,068, entitled “Electronic Gift Greeting”, and filed on Dec. 6, 2001. Each of the aforementioned applications are also assigned to an entity common herewith and incorporated herein by reference for all purposes.

### FIELD OF THE PRESENT INVENTION

The present invention relates broadly to systems associated with providing customized messages and, in particular, to the creation and delivery of a customized message that includes information exchangeable for a stored value card, or other redeemable instrument.

### BACKGROUND OF THE INVENTION

It is known to distribute cash or negotiable instruments in relation to holidays, birthday parties, or as employee incentives. In some cases, this involves sending a note indicating the purpose of the enclosed cash or negotiable instrument. Further, the inventor of the present invention has been involved in creating systems and methods that allow for providing a congratulatory message associated with a negotiable instrument. These systems and methods are more fully disclosed in U.S. patent application Ser. No. ______ (Attorney Docket Number 020375-001011US), entitled “Systems And Methods For Ordering And Distributing Incentive Messages”. The aforementioned application was previously incorporated herein by reference for all purposes.

Some of the systems and methods of the aforementioned applications allow a sender to order a money order and have that money order delivered to a recipient. In some cases, the money order and an associated message are attached and sent to a recipient through the mail. Unfortunately, such a process may not be acceptable where the money order is to be sent to a foreign address. This can be because such money orders are not easily negotiated in a particular foreign country, or the mail to the particular country may not provide a secure means for sending money orders.

Hence, for at least the aforementioned reasons, there exists a need in the art for advanced systems and methods for distributing money orders and other negotiable instruments.

### BRIEF SUMMARY OF THE INVENTION

The present invention provides systems and methods for ordering, preparing, and/or distributing redemption instruments including, but not limited to, stored value cards into another country. In some cases, the systems and methods provide security features allowing them to be used in relation to international applications.

As just one example, the systems and methods can be used to receive requests for redemption instruments that are to be distributed in a foreign country. The requests can include a value to be associated with the redemption instrument(s). In addition, the request may include a congratulatory message provided by the sender, or a congratulatory message selected by the sender from a group of standardized, or stock, congratulatory messages. Yet further, the request may include contact information for the recipient and/or a location at which the redemption instrument is to be distributed.

A document control number, or other identification is generated and associated with the request. The document control number can be maintained on a computer network, but is also sent to the recipient via some form of electronic exchange. The communication to the recipient may further include the congratulatory message and/or directions on where to redeem the document control number. The recipient can then take the document control number to an indicated location, where it is used to access a network and to identify the type and value of redemption instrument that is to be provided to the recipient. The recipient then receives the redemption instrument, and the document control number is invalidated on the system. The redemption instrument can then be exchanged for cash, merchandise, and/or services. Thus, for example, the redemption instrument may indicate a refrigerator of a particular brand and model. The recipient of the redemption instrument may take the redemption instrument to a retailer that carries that type of refrigerator and exchage the redemption instrument for the refrigerator.

As just some of the advantages of the present invention, a recipient can be provided with a congratulatory message and some form of a value incentive, such as cash, merchandise, or services. These can be used for holidays, special occasions, employee incentives, client or customer incentives, marketing purposes, and the like. As yet another advantage, these can be provided to foreign recipients. Foreign use can be facilitated through a more secure transfer medium, and/or can be facilitated through an automatic monetary exchange system. Based on the disclosure provided herein, one of ordinary skill in the art will recognize a myriad of other advantages associated with the present inventions as disclosed and/or claimed herein.

One particular embodiment of the present invention provides systems for distributing stored value cards. The systems include a microprocessor based system accessible via a network that is located in one country, such as, for example, the sending country. The microprocessor based system is associated with a computer readable medium that includes instructions executable by the microprocessor based system for receiving a request to distribute a negotiable stored value card, or other negotiable instrument to a foreign country. In addition, instructions are included that are executable to communicate a message associated with the negotiable stored value card to another microprocessor based system located in the foreign country. The other microprocessor based system can be, for example, a personal computer operated by the recipient or accessible to the recipient. The systems additionally include a stock redemption instrument and a writer both located in the foreign country. The writer is associated with another computer readable medium that includes instructions executable by the writer to associate a value with the stock redemption instrument, such as, for example, a stock stored value card, and thereby create the negotiable redemption instrument, such as, for example, a negotiable stored value card.

In particular cases, the message provided to the recipient includes a document control number that can be used to obtain a negotiable redemption instrument that has been associated with the document control number. In such cases, the document control number can be exchanged for the negotiable redemption instrument, and the document control number then invalidated.

In some cases, the systems can be used to provide stored value cards redeemable through retailers with retail outlets in both the sending country and the foreign country. This can be helpful where, for example, the retailer is well known in the sending country, but not so well known in the foreign country. Such a retailer can send a number of stored value cards to selected recipients in the foreign country to create additional name recognition.

In various instances, the systems include a stored value card printer that is operable to print stock stored value cards. Thus, for example, a blank plastic card can be printed with a retailers name, logo, and/or embossed with an account number. In this way, stock stored value cards can be produced local to the distribution location. In particular cases, the printer is integrated with the stored value card writer that is used to write a value to the stored value card and/or to enable the stored value card for use.

Other embodiments of the present invention provide methods for distributing stored value cards and/or other negotiable redemption instruments. The methods include receiving a request from a sender to distribute a redemption instrument into a first country. The request is received in a second country. A message that includes a document control number is communicated to a recipient located in the first country. The document control number and a value associated with the redemption instrument are accessible to a distributor located in the first country. The recipient then provides the document control number to the distributor in the first country, and the distributor stores a value to a stock stored value card to create a negotiable stored value card corresponding to the requested redemption instrument. In some cases, the methods further include providing the negotiable stored value card to the recipient, and invalidating the document control number.

In particular cases, the message provided to the recipient further includes a congratulatory message. Such a congratulatory message can be provided by the sender, or selected from a group or database of pre-defined congratulatory messages. In various cases, the stock stored value card is preprinted to identify a retailer, while in other cases, the stock stored value card is printed local to the distributor to identify a retailer at which the stock stored value card is associated.

Yet other embodiments of the present invention provide methods for distributing stored value cards that include receiving a request from a sender to distribute a redemption instrument into a first country. The request is received in a second country and includes a congratulatory message and a value. A document control number is associated with the requested redemption instrument and communicated electronically to a recipient located in the first country, along with the congratulatory message. In addition, the document control number and the value is accessible to a distributor in the first country. The document control number is presented by the recipient to the distributor, and the distributor provides a stored value card indicated by the document control number to the recipient. Further, the document control number can be invalidated.

The summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a system in accordance with some embodiments of the present invention;

FIG. 2 illustrates a hardware block diagram useful in relation to the system of FIG. 1;

FIG. 3, illustrates a system in accordance with other embodiments of the present invention;

FIGS. 4 through 6 illustrate various blank, stock, and negotiable redemption instruments useful in accordance with various embodiments of the present invention;

FIG. 7 illustrates an exemplary message in accordance with some embodiments of the present invention; and

FIG. 8 is a flow diagram illustrating a method for ordering, preparing, and distributing redemption instruments in accordance with some embodiments of the present invention.

### DETAILED DESCRIPTION OF THE INVENTION

The present invention is directed to systems, methods and articles for enabling an individual or entity to order a message that can be customized or personalized. The message includes a document control number that is exchangeable for a redemption instrument. As used herein, a redemption instrument can be any instrument that has exchange value. For example, a redemption instrument can be a stored value card, a money order, a gift certificate, checks, vouchers for plane tickets or other merchandise, checks payable to the order of a third party, gift certificates, coupons redeemable for frequent flyer miles or cellular phone minutes, and the like. The messages associated with the redemption instruments can include, but are not limited to, special occasion greetings, congratulatory messages, get well messages, a manager's review of a particular employee, or the like. Such messages can be referred to as a “trophy” because they recognize an accomplishment, milestone, or other occasion to which the message and/or negotiable instrument are related. The messages can be textual, graphical, or a combination thereof. Based on this discussion, one of ordinary skill in the art will recognize a number of other message types and/or redemption instruments that can be combined and used in relation to the present invention.

Additionally, as used herein, the person or entity ordering the message and/or redemption instrument will generally be referred to the “sender” or “requestor.” The person to whom the message and/or redemption instrument is sent will generally be referred to as the “recipient.” In various cases, the recipient will also be the payee identified on the redemption instrument; however, it is within the scope of present invention that a message associated with a redemption instrument could be distributed to a specific recipient, while the redemption instrument could be made payable to a different payee. For example, a company could request the redemption instrument and a message. The message is provided to a recipient congratulating the recipient for a job well done, and directing the recipient to pick up a redemption instrument that is made payable to the recipient's favorite charity.

As just one example, the systems and methods can be used to receive requests for redemption instruments that are to be distributed in a foreign country. The requests can include a value to be associated with the redemption instrument(s). In addition, the request may include a congratulatory message provided by the sender, or a congratulatory message selected by the sender from a group of standardized congratulatory messages. Yet further, the request may include contact information for the recipient and/or a location at which the redemption instrument(s) is(are) to be distributed.

A document control number, or other identification is generated and associated with the request. The document control number can be maintained on a computer network, but is also sent to the recipient via some form of electronic exchange. For example, the document control number can be sent to a recipient via electronic mail. The communication to the recipient may further include the congratulatory message and/or directions on where to redeem the document control number. The recipient can then take the document control number to an indicated location, where it is used to access a network and to identify the type and value of redemption instrument that is to be provided to the recipient. The particular redemption instrument is enabled, thus making a negotiable redemption instrument, and the document control number is invalidated on the system. The negotiable redemption instrument can then be exchanged for cash, merchandise, and/or services as specified.

As just some of the advantages of the present invention, a recipient can be provided with a congratulatory message and some form of a value incentive, such as cash, merchandise, or services. These can be used for holidays, special occasions, employee incentives, client or customer incentives, and the like. As yet another advantage, these can be provided to foreign recipients. Foreign-use can be facilitated through a more secure transfer medium, and/or can be facilitated through an automatic monetary exchange system. Based on the disclosure provided herein, one of ordinary skill in the art will recognize a myriad of other advantages associated with the present inventions as disclosed and/or claimed herein.

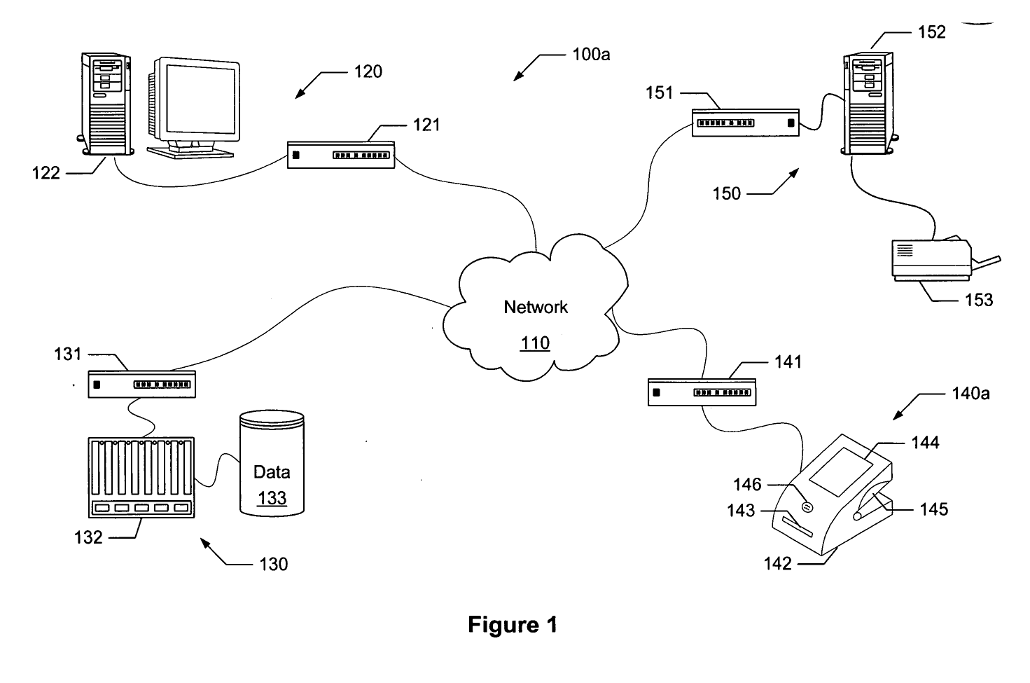

Referring to FIG. 1, a system 100a is illustrated that includes a sender workstation 120, a recipient workstation 150, a distributor workstation 140a, and a central office 130, each in communication via a communication network 110. Communication network 110 can be any communication network capable of providing communications between the various elements of system 100a. In some embodiments, communication network 110 is the Internet providing message based communication between any of sender workstation 120, recipient workstation 150, distributor workstation 140a, and/or central office 130. In other embodiments, communication network 110 comprises a TCP/IP compliant virtual private network (VPN). In yet other embodiments, communication network 110 includes the Internet for communication between sender workstation 120 and central office 130 and between central office 130 and recipient workstation 150, and a VPN between central office 130 and distributor location 140a. However, it should be recognized that other communication networks could be used to provide similar functionality. For example, communication network 110 can be a local area network (LAN), a wide area network (WAN), a telephone network, a cellular telephone network, a virtual private network (VPN), the Internet, an optical network, a wireless network, or any other similar communication network or combination thereof.

Sender workstation 120 includes a microprocessor based device 122 that includes a computer readable medium. In particular embodiments, microprocessor based device 122 is a personal computer (“PC”), while in other cases, microprocessor based device 122 is a personal digital assistant (“PDA”), a notebook computer, a cell phone, or the like. In some cases, the computer readable medium includes a hard drive, a random access memory (“RAM”), and a removable storage element, such as a floppy disk or a CDROM. Microprocessor based device 122 is communicably coupled to network 110 via a coupling device 121. Coupling device 121 can be a modem including, but not limited to, a V.91 modem, an xDSL modem, an ISDN modem, a wireless modem, or the like.

Recipient workstation 150 includes a microprocessor based device 152 that includes a computer readable medium. In particular embodiments, microprocessor based device 152 is a PC, but can be a PDA, a notebook computer, a cell phone, or the like. In some cases, the computer readable medium includes a hard drive, a RAM, and a removable storage element, such as a floppy disk or a CDROM. Microprocessor based device 152 is communicably coupled to network 110 via a coupling device 151 that can be, for example, a V.91 modem, an xDSL modem, an ISDN modem, a wireless modem, or the like. Recipient workstation 150 also includes a printer 153. In some cases a color printer is desirable for converting an electronic trophy into a color hardcopy.

Central office 130 includes a microprocessor based device 132, that can be, for example, a network server. Microprocessor based device 132 is communicably coupled to a database 133, and to network 110 via a coupling device 131. Coupling device 131 can be, but is not limited to, a network hub, a router, a V.91 modem, an ISDN modem, an xDSL modem, or the like. Based on the description provided herein, one of ordinary skill in the art may recognize that distributor workstation 140 and recipient workstation 150 may be located in the same country and/or geographic vicinity. This country and/or geographic vicinity may be remote from and/or foreign to the location of central office 130 and/or sender workstation 120.

Distributor workstation 140a includes a microprocessor based, point of sale device 142 (“POS device”) that includes a computer readable medium. In particular embodiments, POS device 142 includes a display 144, a card reader 145, a speaker 146, and a media bay 143. POS device 142 is communicably coupled to network 110 via a coupling device 141 that can be, but is not limited to, a V.91 modem, an xDSL modem, an ISDN modem, a wireless modem, or the like. Media bay 143 can include a printer, and an electronic writer. Thus, for example, a stock stored value card can be inserted into media bay 143 and written with a value and other information. Alternatively, a stock check can be inserted into media bay 143 and printed with a recipient, a value, and other information.

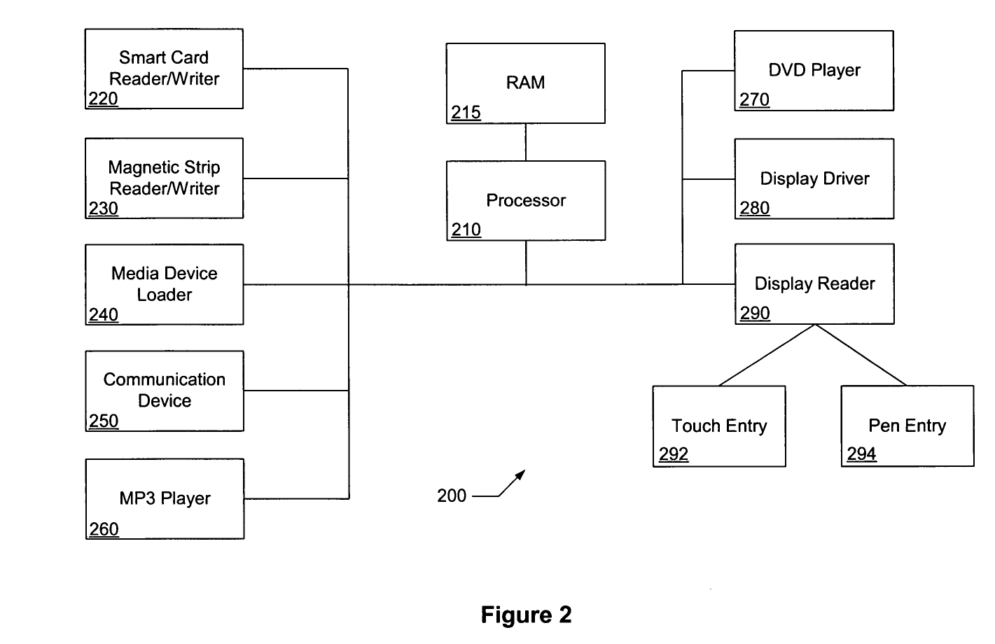

POS device 142 can provide a number of functions useful in relation to preparing and/or distributing redemption instruments in accordance with the present invention. One such POS device useful in relation to the present invention is illustrated in schematic form in FIG. 2. Such a POS device 142 is more fully described in U.S. patent application Ser. No. ______ (Attorney Docket No. 020375-034100), entitled “Peripheral Point-Of-Sale Systems And Methods Of Using Such”, and previously incorporated herein by reference for all purposes. Based on the disclosure provided herein, one of ordinary skill in the art will appreciate a number of other POS devices that can be used in relation to the present invention. Such POS devices can include less functionality, or more functionality than that discussed in relation to FIG. 2.

Turning to FIG. 2, a logical block diagram 200 of one embodiment of POS device 142 is illustrated. POS device 142 includes a Central Processing Unit (“CPU”) 210 electrically coupled to a memory 215, a smart card reader 220, a magnetic strip reader 230, a media device loader 240, a communication device 250, an MP3 player 260, a DVD player 270, a display driver 280, and a display reader 290 including a touch entry interface 292 and a pen entry interface 294.

CPU 210 can be any microprocessor capable of controlling the various functions of POS device 110 described herein. In some embodiments, CPU 210 is a thirty-two bit Reduced Instruction Set Computer (“RISC”) processor. In one particular embodiment, CPU 210 is a Motorola 68302 processor. In other embodiments, CPU 210 is a pair of 32-bit processors one tasked to control the various components associated with POS device 142, and the other processor tasked with operating the various software applications executed in relation to POS device 142.

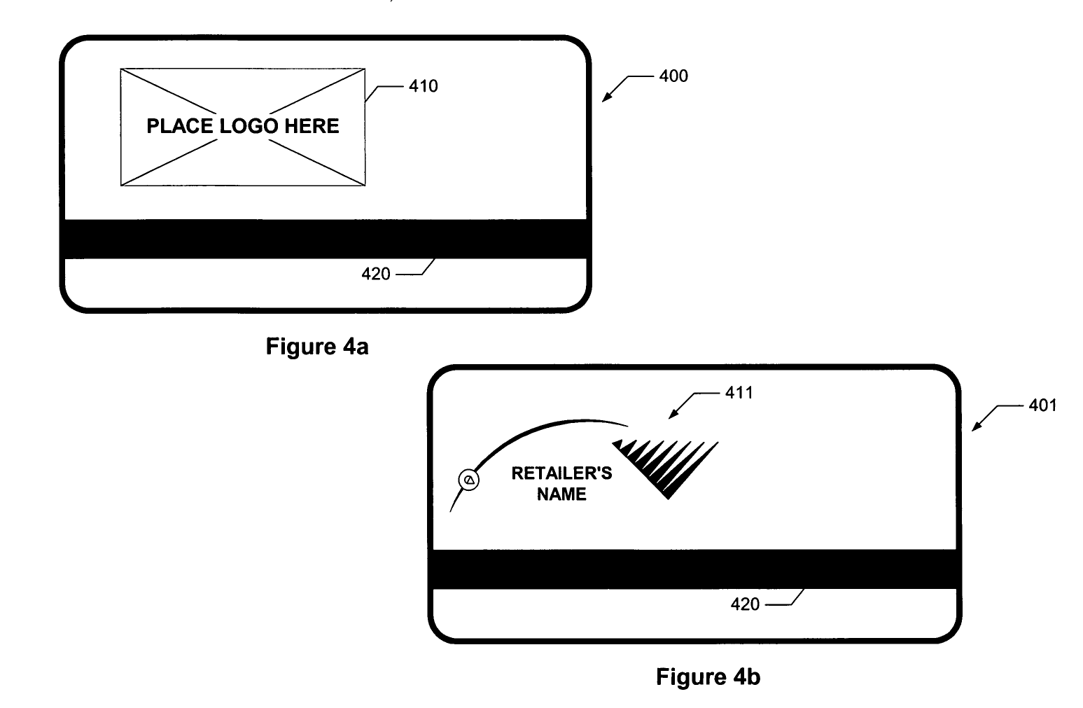

Smart card reader/writer 320 provides functionality used to read and write information to and from various smart cards. In some embodiments, smart cards are inserted via media bay 143 and smart card reader/writer 220 is electrically coupled to the interface circuitry of media bay 143. In some cases, media bay 143 provides an ability to write a smart card to increase a value maintained thereon. Alternatively, or in addition, media bay 143 can be used to write a value to and/or enable a stored value card. In yet other embodiments, media bay 143 can provide access to a printer that prints a certificate, money order, or other negotiable instrument with sufficient information to make the negotiable instrument valid. Thus, as will be further described below in relation to FIGS. 4 through 6, a blank check can be inserted into media bay 143 and imprinted with a signature, recipient, and amount.

Communication device 250 can be a circuit implementing a communication mechanism capable of transmitting and receiving information across communication network 110 via modem 141. In some embodiments, communication device 250 includes modem 141 incorporated therein. Based on the disclosure provided herein, one of ordinary skill in the art will recognize a number of communication types and/or circuits that can be employed in relation to communication device 250.

Media device loader 240 can be a circuit capable of receiving data and loading it to a media device coupled to media bay 143. Thus, for example, where a media device has a PCMCIA interface, media device loader 240 can support loading a media device via a PCMCIA interface. Alternatively, where a USB interface is used, media device loader 240 can support loading a media device via a USB interface. Based on the disclosure provided herein, one of ordinary skill in the art will recognize a number of other interfaces that can be supported and circuitry associated therewith.

MP3 player 260 and DVD player 270 can be incorporated to preview various media that can be loaded via POS device 142. For example, an audio recording may be accessed by POS device 142, and played by MP3 player 260 with the output being provided to speaker 146, or through an external audio connector associated with POS device 142. Alternatively, a video recording may be accessed by POS device 142, and played by MP3 player 260 and DVD player 270 with the output being provided to speaker 146 and display 144. Display 144 can be driven via a display driver 280, which in some cases is a graphics controller. Further, display reader 290 provides for receiving input via display 144. Such input can be received via a touch entry interface circuit 292, and a pen entry interface circuit 294.

Based on the disclosure provided herein, one of ordinary skill in the art will recognize other functionality that can be incorporated into POS device 142. For example, a wireless interface may be incorporated for reading a transponder carried on a key chain of a user. Some of this additional functionality is more fully disclosed in U.S. patent application Ser. No. 10/116,689, entitled “Systems And Methods For Performing Transactions At A Point-Of-Sale”; U.S. patent application Ser. No. 10/116733, entitled “Systems and Methods for Deploying a Point-of-Sale System”, U.S. patent application Ser. No. 10/116,686, entitled “Systems and Methods for Utilizing a Point-of-Sale System”, U.S. patent application Ser. No. 10/116,735, entitled “Systems and Methods for Configuring a Point-of-Sale System”, and U.S. patent application Ser. No. 10/163,188, Entitled “Intra-Organization Negotiable Instrument Production And Messaging”, each of which were previously incorporated herein by reference for all purposes.

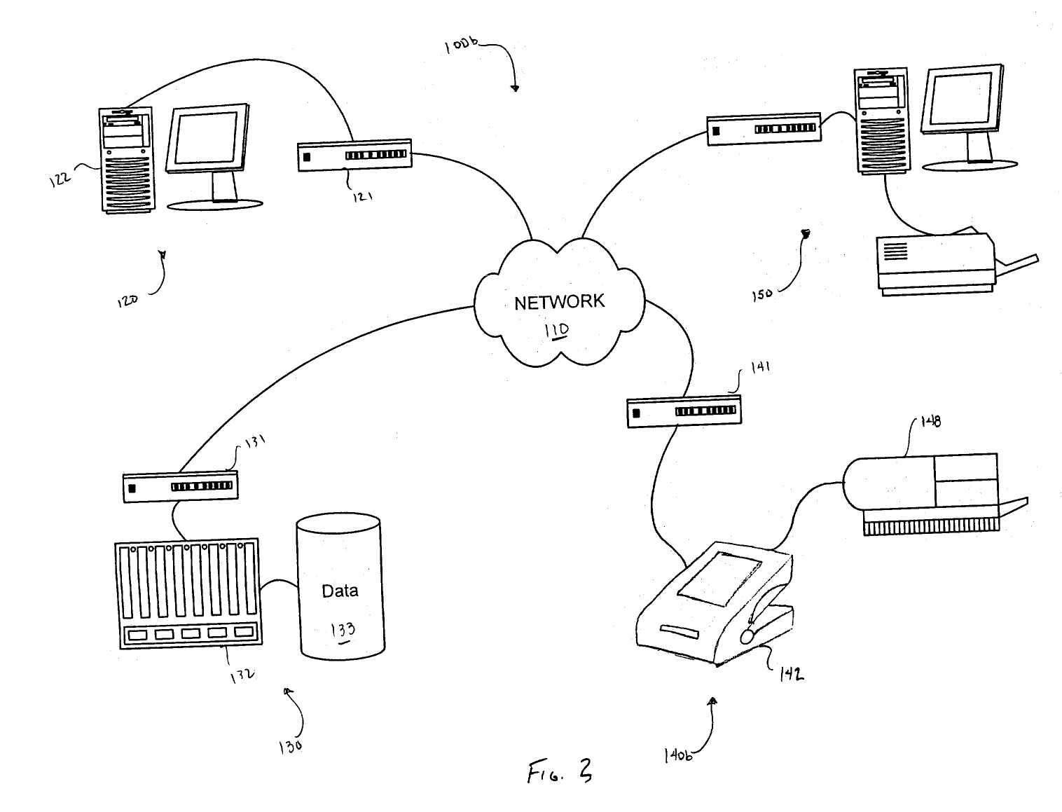

Turning to FIG. 3, a system 100b is depicted that is similar to the previously described system 100a. The difference is the addition of a production device 148 to distributor workstation 140. Production 148 device can be used to create stock redemption instruments from blank redemption instruments as is more fully discussed in relation to FIGS. 4 through 6 below. In the embodiment of system 100b, it is possible to both enable and produce redemption instruments at the distribution location. Production device 148 can include an embosser and/or a printer for placing logos and other information on blank redemption instruments. This can include printing on paper or plastic stock, and printing text and graphics. Based on this disclosure, one of ordinary skill in the art will appreciate that POS device 142 and production device 148 can be integrated into a single device.

As previously suggested, some embodiments of the present invention include producing stock redemption instruments from blank redemption instruments, and for producing negotiable redemption instruments from stock redemption instruments. For the purposes of this document, a blank redemption instrument is a redemption instrument that does not include the name of a retailer or other entity that will redeem the redemption instrument. A stock redemption instrument is a redemption instrument that has been printed with information about a redeeming entity, but has not been enabled for exchange. A negotiable redemption instrument, on the other hand, is a redemption instrument that has been enabled for exchange.

Various exemplary redemption instruments are discussed in relation to FIGS. 4 through 6. Turning to FIG. 4a, a blank stored value card 400 is illustrated. Blank stored value card 400 includes a plastic body with a magnetic strip 420 and a logo location 410. Some embodiments of production device 148 can accept blank stored value card 400, and print a logo 411 associated with a particular redeeming entity, thus creating a stock stored value card 401 as depicted in FIG. 4b. In addition, POS device 142 can write a value and/or other enabling information to magnetic strip 420 to thus create a negotiable stored value card. Where production device 148 is not available at distributor workstation 140, stock stored value cards 401 can be produced remotely, and delivered to the location of distributor workstation 140. At distributor location 140, POS device 142 can convert the delivered stock stored value cards to negotiable stored value cards.

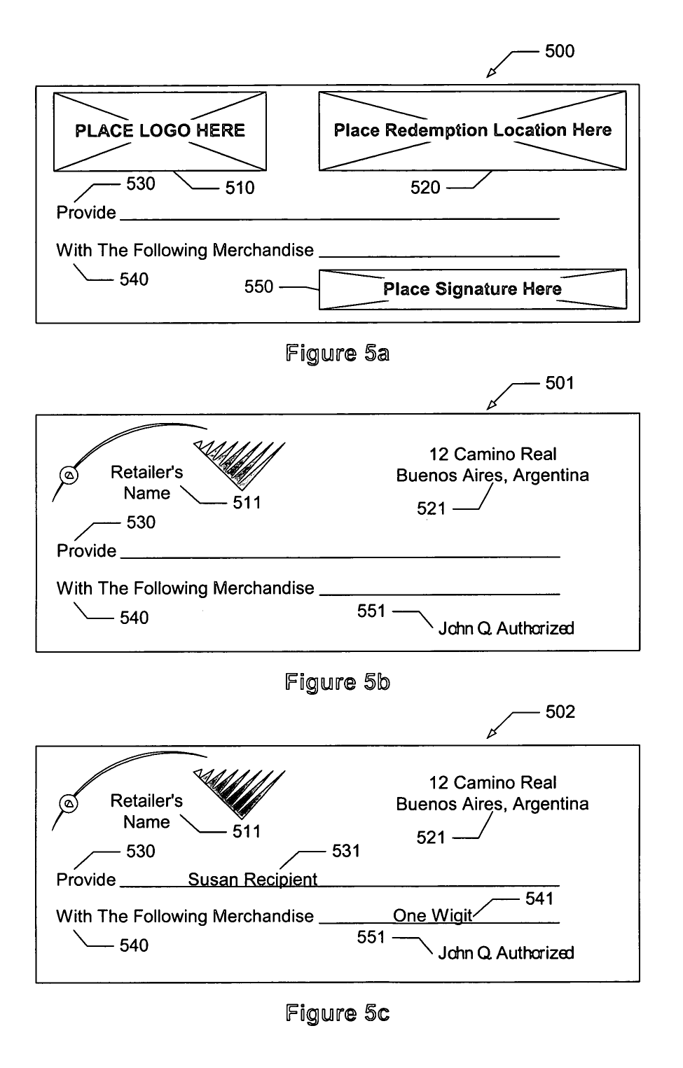

Turning to FIG. 5a, a blank coupon 500 is illustrated. Blank coupon 500 includes a paper body with various pre-printed fields and reserved locations. Pre-printed fields can include, but are not limited to, a “Provide” field 530 and a “With the Following Merchandise” field 540. In addition, a logo location 510, a redemption location 520, and a signature location 550 are reserved. Some embodiments of production device 148 can accept blank coupon 500, and print a logo 511 associated with a particular redeeming entity, an address for redemption 521, a signature 551, and the like in the reserved locations. By doing so, blank coupon 500 is converted to a stock coupon 501 as depicted in FIG. 5b. In addition, POS device 142 can write a value and/or other enabling information to the blanks next to “Provide” field 530 and “With the Following Merchandise Field” 540 to thus create a negotiable coupon 502 as depicted in FIG. 5c. As illustrated, a recipient identification 531 is printed next to “Provide” field 530, and a merchandise identification 541 is printed next to “With the Following Merchandise Field” 540. In some cases, these identifications 531, 541 are printed using magnetic ink to provide a more secure coupon. Where production device 148 is not available at distributor workstation 140, stock coupons 501 can be produced remotely, and delivered to the location of distributor workstation 140. At distributor location 140, POS device 142 can convert the delivered stock coupons to negotiable coupons.

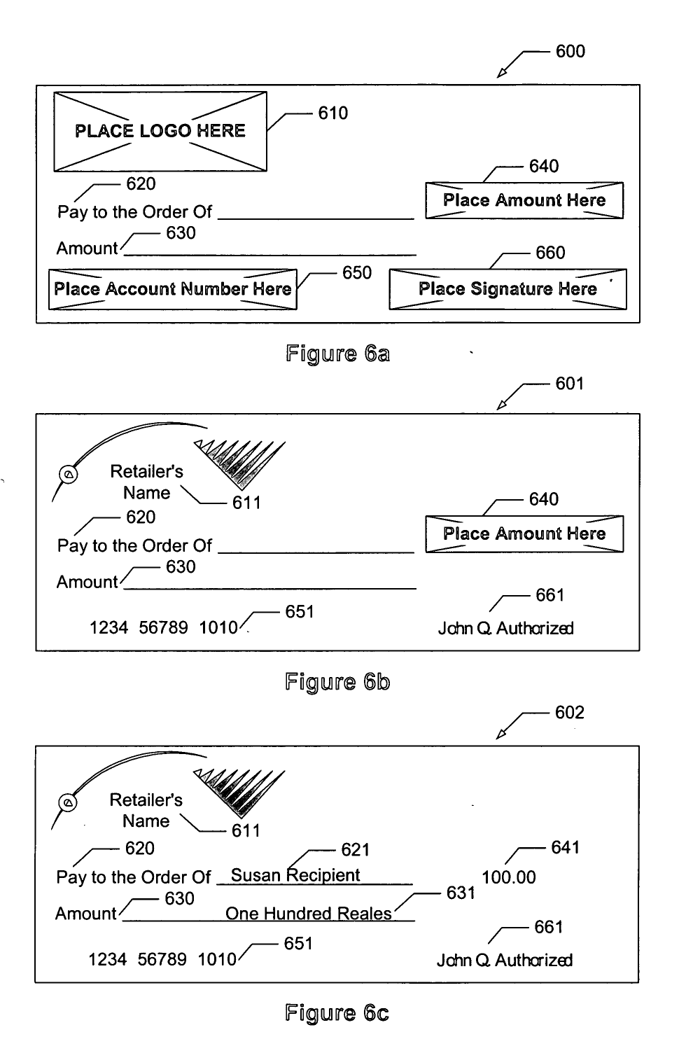

Turning to FIG. 6a, a blank check 600 is illustrated. Blank check 600 includes a paper body with various pre-printed fields and reserved locations. Preprinted fields can include, but are not limited to, a “Pay to the Order Of” field 620 and an “Amount” field 630. In addition, a logo location 610, an amount location 640, an account number location 650, and a signature location 660 are reserved. Some embodiments of production device 148 can accept blank check 600, and print a logo 611 associated with a payor, an account number 651, a signature 661, and the like in some of the reserved locations. By doing so, blank check 600 is converted to a stock check 601 as depicted in FIG. 6b. In addition, POS device 142 can write a value and/or other enabling information to the blanks next to “Pay to the Order Of” field 620, “Amount” field 630, and at amount location 640 to thus create a negotiable coupon 602 as depicted in FIG. 6c. As illustrated, a recipient identification 621 is printed next to “Pay to the Order Of” field 620, a written amount 6311 is printed next to “Amount” 630, and a numerical amount 641 is printed at amount location 640. In some cases, the aforementioned information is printed using magnetic ink to provide a more secure check. Where production device 148 is not available at distributor workstation 140, stock checks 601 can be produced remotely, and delivered to the location of distributor workstation 140. At distributor location 140, POS device 142 can convert the delivered stock checks to negotiable checks.

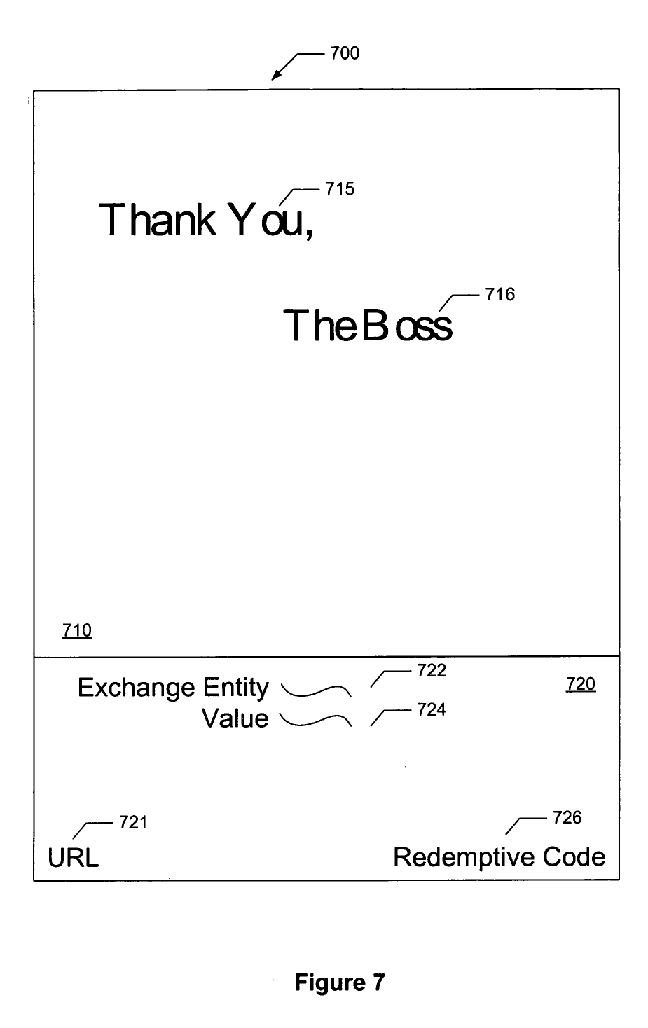

Referring to FIG. 7, an embodiment of a message 700 with a document control number in accordance with some embodiments of the present invention is depicted. Message 700 includes a trophy 710. Trophy 710 can include various attributes including those described in U.S. patent application Ser. No. ______ (Attorney Docket Number 020375-01011US), entitled “Systems And Methods For Ordering And Distributing Incentive Messages”, that was previously incorporated herein by reference for all purposes. For example, trophy 710 can include a congratulatory message 715 and a signature 716. Message 700 further includes an exchange portion 720. In some cases, exchange portion 720 can be separated from trophy 710 by an electronic page break. In other cases, exchange portion 710 is formed such that trophy 710 can be displayed without showing exchange portion 720. For example, exchange portion 720 could be printed on the back, or non-visible side of trophy 710. Based on this disclosure, one of ordinary skill in the art will recognize other approaches for associating exchange portion 720 with trophy 710.

Exchange portion 710 identifies a value 724 that can be obtained by providing document control number 726 to an exchange entity 722 with a distributor workstation 140. For example, exchange entity 722 may include an indication of an entity that can redeem exchange portion 710, such as WESTERN UNION™. Further, directions for getting to one or more exchange entities may be provided, telephone contact information, and/or an email address. As yet another alternative, a uniform record locator (“URL”) 728 can be included that provides an Internet address for a site providing directions on redemption, or providing the location of the nearest location where document control number 726 can be redeemed. Value can be a cash amount, a merchandise item, an amount exchangeable for items from a merchandise catalog, services, and/or the like. Document control number 726 is used to identify the proper value that may have been set aside and/or marked for use in relation to document control number 726. In some cases, document control number 726 is an alphanumeric code that can be unique to message 700 and/or exchange portion 710.

In various cases, one or more security features can be included. For example trophy 710 may include the name of a person authorized to redeem exchange portion 710. In such a case, an identification such as a driver's license may be used when document control number 726 is offered for exchange to assure that the proper person is redeeming exchange portion 710. Alternatively, another code, or security code, may be maintained in relation to document control number 726, but not provided in relation to exchange portion 710. Such a security code could be known to one or more redeemers, but not to the general public. For example, the security could be a home telephone number, an employee number, a home address, an email address, or the like for one or more potential redeemers. Thus, for example, when document control number 726 is provided, the redeemer may be queried for their social security number. If the social security number matches the one or more social security numbers associated with document control number 726, value 724 is provided to the redeemer in the form of a negotiable redemption instrument, and document control number 726 is voided to disallow any reuse.

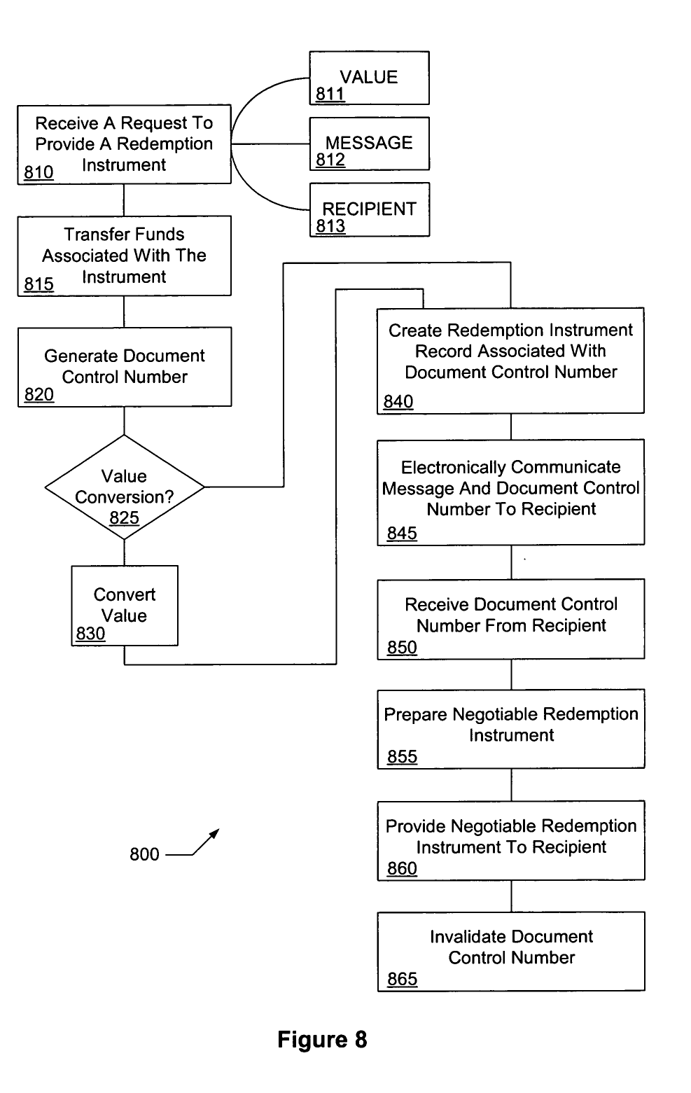

Turning now to FIG. 8, a flow diagram 800 illustrates a method in accordance with the present invention for ordering, preparing, and distributing redemption instruments and associated messages. Following flow diagram 800, a request to prepare and distribute a negotiable redemption instrument is received from a sender (block 810). The request can be received in any number of ways. For example, in one particular embodiment, server 132 provides a variety of web pages through which the request can be issued. Some examples of such web pages are more fully described in U.S. patent application Ser. No. ______ (Attorney Docket Number 020375-001011US), entitled “Systems And Methods For Ordering And Distributing Incentive Messages”, that was previously incorporated herein by reference for all purposes. The sender can access the web pages, provide the appropriate information, and send the request. Part of the information provided with the request can be a source of funds used to cover the costs of the processes. Based on this disclosure, one of ordinary skill in the art will recognize a variety of other methods for providing the request including, for example, sending a physical request through the mail, or visiting central office 130 or an entity providing receiving services and providing the request directly to them.

The request can include a value of the redemption instrument (block 811). As previously discussed, the value can be merchandise, cash, services, or the like. For example, the value may be a cash amount translated into a local currency and useful in relation to a particular retailer, or group of retailers. Alternatively, the value may be a cash amount converted into a local currency. As yet another example, the value may be a merchandise item or service provided by a particular retailer or group of retailers.

The request can also include a message (block 812). The message can be any of the previously discussed message types. This message can be provided by the sender, or selected by the sender from a database of stock messages maintained on database 133. Thus, for example, a web page may be provided by central office 130 that includes a number of stock messages that can be selected. Alternatively, a graphic and/or textual message may be supplied to central office 130 via sender workstation 120. In addition, the request can also include a recipient designation (block 813). The recipient designation can include an email address, physical address, name, and the like about an intended recipient of the requested redemption instrument.

Funds associated with the requested redemption instrument can be transferred to support the request (block 815). This can include an automatic transfer from a sender's account to an account associated with central office 130. Alternatively, the sender may provide a credit card account number which can be charged by central office 130. Based on this disclosure, one of ordinary skill in the art will recognize a number of ways for accepting payment for a requested redemption instrument.

A document control number is also generated (block 820). As further discussed below, this document control number can be maintained in association with the value, message, recipient, and/or other information associated with the requested redemption instrument. It is next determined whether a currency conversion is to be done (block 825). Where a conversion is either desired or required, the conversion is performed (block 830). Thus, for example, where the currency in which the request is made is in U.S. Dollars, and the recipient is located in Great Britain, a conversion may be made from U.S. Dollars to Pounds Sterling. Alternatively, the conversion may not be desired, but rather the recipient may be given a redemption instrument with an amount in U.S. Dollars, or the currency of the sender location.

A redemption instrument record is created that includes the document control number, the value, the recipient information, information about the sender, and the message (block 840). The record is accessible using one or all of the document control number, the recipient information, and/or the sender information. Thus, for example, when presented with the document control number, a distributor can access the record and prepare an appropriate redemption instrument. In some cases, this record is transferred to the location of the distributor workstation near the recipient, or to a database local to a number of distributor workstations near the recipient. In some cases, such an approach is desirable to allow ready access to the record. In other cases, however, the record is maintained on database 133 remote from distributor locations near the recipient. The message and the document control number are electronically communicated to the recipient (block 845). As an example, the communication can appear as message 700 described above. The recipient can then print the message. The trophy can be displayed, while the exchange portion with the document control number can be redeemed for the redemption instrument.

A recipient can then present the document control number to an entity capable of preparing and/or distributing redemption instruments (block 850). Such entities can include a distributor workstation. The negotiable redemption instrument indicated by the document control number is then prepared (block 855). As described above in relation to FIGS. 4 through 6, this can include preparing a stock redemption instrument from a blank redemption instrument, and/or preparing the negotiable redemption instrument from the stock redemption instrument. The negotiable redemption instrument is then provided to the recipient (block 860), and the document control number is invalidated (block 865).

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for preparing and distributing redemption instruments, the system comprising:
a first microprocessor based system accessible via a network, wherein the first microprocessor based system is located in a first country;
a first computer readable medium associated with the first microprocessor based system, wherein the first computer readable medium includes instructions executable by the first microprocessor based system for receiving a request to distribute a negotiable redemption instrument to a second country, and wherein the first computer readable medium further includes instructions executable by the first microprocessor based system to communicate a message associated with the negotiable redemption instrument to a second microprocessor based system located in the second country; and
wherein the first microprocessor based system is communicably coupled to a writer located in the second country, and wherein the writer includes a second computer readable medium, and wherein the second computer readable medium includes instructions executable by the writer to associate a value with a stock redemption instrument and thereby create the negotiable redemption instrument.

2. The system of claim 1, wherein the negotiable redemption instrument is a stored value card.

3. The system of claim 1, wherein the negotiable redemption instrument is a money order.

4. The system of claim 1, wherein the negotiable redemption instrument is a certificate that can be exchanged for merchandise or services.

5. The system of claim 1, wherein the second microprocessor based system is a personal computer associated with a recipient of the negotiable redemption instrument.

6. The system of claim 2, wherein the first computer readable medium further includes instructions executable by the first microprocessor based system for receiving the message to be associated with the negotiable redemption instrument, and wherein the message is a congratulatory message.

7. The system of claim 1, wherein the stock redemption instrument is preprinted to identify a retailer.

8. The system of claim 7, wherein the retailer maintains a retail outlet in both the first country and the second country.

9. The system of claim 2, the system further comprising:
a stored value card printer, wherein the stored value card printer is operable to print the stock stored value card.

10. The system of claim 9, wherein the stored value card printer is integrated with the stored value card writer.

11. The system of claim 9, wherein the stored value card printer is operable to receive an identification of a retailer, and to print the identification of the retailer on a card to create the stock stored value card.

12. The system of claim 1, wherein the message includes a document control number.

13. The system of claim 9, wherein the document control number is exchangeable for the negotiable redemption instrument.

14. A method for distributing redemption instruments, the method comprising:
receiving a request from a sender to distribute a selected redemption instrument into a first country, wherein the request is received in a second country;
communicating a message to a recipient located in the first country, wherein the message includes a document control number;
communicating the document control number and a value to a distributor in the first country;
receiving the document control number in the first country; and
storing the value to a stock redemption instrument to create a negotiable redemption instrument corresponding to the selected redemption instrument.

15. The method of claim 14, wherein the negotiable redemption instrument is a stored value card, the method further comprising:
providing the negotiable stored value card to the recipient; and
invalidating the document control number.

16. The method of claim 14, wherein the message further includes a congratulatory message, and wherein the message is received at a personal computer maintained by the recipient.

17. The system of claim 16, the method further comprising:
receiving the congratulatory message from the sender.

18. The method of claim 16, wherein the congratulatory message is selected by the sender from a database of congratulatory messages.

19. The system of claim 14, wherein the stock redemption instrument is preprinted to identify a retailer.

20. The system of claim 14, the method further comprising:
printing the stock redemption instrument to identify a retailer at which the stock redemption instrument is associated.

21. A method for distributing stored value cards, the method comprising:
receiving a request from a sender to distribute a selected redemption instrument into a first country, wherein the request is received in a second country, and wherein the request includes a congratulatory message and a value;
providing a document control number associated with the requested redeemable value instrument;
electronically communicating the congratulatory message and the document control number to a recipient located in the first country;
communicating the document control number and the value to a distributor in the first country;
receiving the document control number from the recipient in the first country; and
storing the value to a stock stored value card to create a negotiable stored value card corresponding to the selected redemption instrument.

22. The method of claim 21, the method further comprising:
providing the negotiable stored value card to the recipient; and
invalidating the document control number.

23. The method of claim 21, wherein the stock stored value card is preprinted to identify a retailer.

24. The method of claim 21, the method further comprising:
printing the stock stored value card to identify a retailer at which the stock stored value card is associated.
